(19) United States
(12) Patent Application Publication
(10) Pub. No.: US 2022/0124262 A1
(43) Pub. Date: Apr. 21, 2022

(54) PASSIVE HYPERSPECTRAL VISUAL AND INFRARED SENSOR PACKAGE FOR MIXED STEREOSCOPIC IMAGING AND HEAT MAPPING

(71) Applicant: SCOUT Inc., Alexandria, VA (US)

(72) Inventors: Sergio Gallucci, Pleasant Gap, PA (US); Eric Ingram, Alexandria, VA (US)

(21) Appl. No.: 17/501,901

(22) Filed: Oct. 14, 2021

Related U.S. Application Data
(60) Provisional application No. 63/092,450, filed on Oct. 15, 2020.

(51) Int. Cl. H04N 5/33; G01J 3/28; H04N 13/239

(52) U.S. Cl. CPC H04N 5/332; G01J 2003/2826; H04N 13/239; G01J 3/2823

(57) ABSTRACT

Disclosed herein are systems, devices, and methods related to mixed stereoscopic imaging and heat mapping in outer space. In particular, a passive hyperspectral visual and infrared sensing system used for mixed stereoscopic imaging and heat mapping of objects in outer space is disclosed. One or more versions of the system is referred to herein as “SCOUT-Vision” and includes a multi-sensor package providing remote and passive mapping of physical objects in space, including, but not limited to, depth, surface, and heat mapping. In various embodiments, SCOUT-Vision includes a plurality of sensors (e.g., visual spectrum electro-optical sensors) to image objects and determine their size, distance, and/or motion. SCOUT-Vision may additionally include one or more infrared thermal sensors for conducting surface thermal mapping of remote objects. The one or more thermal sensors are capable of generating inputs to various algorithms, thereby enabling SCOUT-Vision to filter out background noise.

### CROSS-REFERENCE TO RELATED APPLICATIONS

This application claims priority to U.S. Provisional Application No. 63/092,450, filed Oct. 15, 2020, which is hereby incorporated by reference in its entirety.

### FIELD OF THE INVENTION

The application relates generally to imaging and heat mapping. In particular, the application relates to novel systems, devices, and methods related to mixed stereoscopic imaging and heat mapping in outer space, including, for instance, a passive hyperspectral visual and infrared sensing system.

### BACKGROUND

Imaging and heat mapping are used in a variety of applications, including the mapping of remote objects in outer space. Remote sensing of objects, autonomous diagnostics, and autonomous navigation in space are especially valuable to many entities, such as, for instance, commercial and non-commercial satellite operators, and commercial and non-commercial satellite manufacturers.

Current state-of-the-art technology, however, does not allow for autonomous analysis, characterization, and/or mapping of observed objects in outer space. Such technology is embodied in, for example, manual infrared thermal binoculars. Not only must this technology be used manually on the ground, but it only provides one type of mapping (i.e., a thermal map).

Moreover, thermal binoculars used for night vision, and similar technology, do not integrate sensors for digital replication and autonomous analysis within the users' field of view. Such binoculars are also lacking in that they are built for manual use assisted by human binocular capabilities, and simply filter the sight for the infrared (IR) spectrum, without the integration of both the visual spectrum and thermal optics.

Given the foregoing, there exists a significant need for novel technology that enables mixed stereoscopic imaging and heat mapping for objects in outer space.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In general, the present disclosure is directed towards imaging and heat mapping. In particular, the application relates to novel systems, devices, and methods related to mixed stereoscopic imaging and heat mapping, especially in outer space.

At least one embodiment of the invention is a passive hyperspectral visual and infrared sensing system used for mixed stereoscopic imaging and heat mapping of objects in outer space. The system, which may also be referred to herein as “SCOUT-Vision,” has trinocular capabilities, i.e., the thermal optics and stereoscopic visual spectrum optics operate in parallel.

In at least one embodiment, SCOUT-Vision comprises a multi-sensor package providing remote and passive mapping of physical objects in space, including, but not limited to, depth, surface, and heat mapping. SCOUT-Vision further produces visual spectrum data as well as a thermal overlay, which are internally processed to produce a three-dimensional (3D) representation of the observed field of view.

In at least one embodiment of the disclosure, a system for remote and passive mapping of one or more physical objects in space comprises a plurality of sensors for imaging one or more physical objects and for determining size, distance, and/or motion of the physical objects, thereby producing imaging data for the one or more physical objects, one or more infrared thermal sensors for collecting thermal data for the one or more physical objects, and at least one computer comprising at least one processor, wherein the at least one processor is operatively connected to at least one non-transitory, computer readable medium having computer-executable instructions stored thereon, wherein, when executed by the at least one processor, the computer executable instructions carry out a set of steps comprising: combining the imaging data and the thermal data to generate one or more three-dimensional (3D) maps of the one or more physical objects.

In at least one embodiment of the system, the plurality of sensors comprises visual spectrum electro-optical sensors.

In at least a further embodiment of the system, the one or more thermal sensors generate inputs to a plurality of algorithms for filtering out background noise from the imaging data, and wherein the plurality of algorithms comprises blob and edge detection algorithms and/or contrast algorithms. The at least one processor may also execute one or more of the plurality of algorithms.

In at least an additional embodiment of the system, the set of steps further comprises processing the imaging data in order to ascertain guidance, navigation, thermal anomalies, and/or control ephemera of the one or more physical objects.

In at least one embodiment of the system, the one or more 3D maps comprise one or more overlays that display the imaging data and/or the thermal data.

In at least a further embodiment of the system, the thermal data comprises location and distribution of internal thermal sources within the one or more physical objects.

In at least an additional embodiment of the system, the set of steps further comprises using the imaging data and/or the thermal data to generate a digital mesh around the one or more physical objects, and using the digital mesh to generate thermal distributions and/or thermodynamic models of the one or more physical objects.

The system may, in at least one embodiment, interface with one or more control systems that provide guidance, navigation, command, control, and/or data handling for one or more objects placed into space and/or orbit.

In at least a further embodiment of the system, the imaging data comprises panchromatic spectrum data, red green blue (RGB) data, one or more indicators of the one or more physical objects, pointing and orientation information relating to the one or more physical objects, relative location of the one or more physical objects, and/or depth information representing distances between the system and the one or more physical objects. Further, the imaging data may have a resolution of between 0.5 and 10 cm² per pixel at an operational range of between 2 and 100 m.

In at least an additional embodiment of the system, the plurality of sensors and the one or more infrared thermal sensors operate in parallel.

In at least one embodiment of the system, the set of steps further comprises using the one or more 3D maps to generate one or more thermal overlays of surfaces of the one or more physical objects, and generating, for each of the one or more physical objects, a simulated object that has six degrees-of-freedom ephemera.

The set of steps may additionally comprise using the one or more thermal overlays to define, for each object in the one or more objects, locations and operational behaviors of internal thermal sources, external thermal sources, and/or modes of heat transfer.

The set of steps may also comprise using the one or more 3D maps to generate a thermodynamic and environmental model that is usable to check accuracy of the operational behaviors, where the model comprises a finite element representation of each of the simulated objects.

The set of steps may additionally comprise utilizing the thermal data to generate one or more heat maps of the one or more objects.

The set of steps may further comprise utilizing the thermal data to determine existence and/or position of one or more thermal anomalies underneath a surface of the one or more physical objects.

The set of steps may also comprise comparing the thermal data to expected thermal properties of the one or more physical objects, and identifying thermal abnormalities in the one or more physical objects.

The set of steps may additionally comprise diagnosing the thermal abnormalities using, at least in part, the imaging data, wherein the imaging data comprises one or more indicators of the one or more physical objects, pointing and orientation information relating to the one or more physical objects, relative location of the one or more physical objects, and/or depth information representing distances between the system and the one or more physical objects.

In at least one embodiment of the disclosure, a system for remote and passive mapping of one or more physical objects in space comprises a plurality of lenses that provide a field of view for a user, an infrared sensor that measures infrared light radiating from one or more objects within the field of view, a plurality of visible spectrum sensors that measure visible light and radiation from the one or more objects within the field of view, one or more electronic circuits and/or computer processors that process data provided by both the infrared sensor and the plurality of visible spectrum sensors, thereby generating information for a user; and a viewing area that displays the information to the user.

The information may also comprise a visual image of the field of view and a thermal image of the field of view.

The one or more electronic circuits and/or computer processors may further analyze the data to determine, within a body-centric reference frame, six degree-of-freedom orientation and navigation vectors for the one or more physical objects.

In at least one embodiment of the disclosure, a method for mapping one or more objects in a field of view comprises collecting a plurality of images of one or more objects in a field of view, wherein the plurality of images comprise one or more images in the visible portion of the electromagnetic spectrum and one or more images in the infrared portion of the electromagnetic spectrum, performing infrared filtering of the plurality of images, performing blob detection of the plurality of images, performing a visible spectrum object offset comparison of the plurality of images, determining one or more distances between the one or more objects, determining one or more sizes of the one or more objects, and processing the one or more distances and the one or more sizes to determine location and displacement of the one or more objects along a Z-axis extending towards and away the field of view, thereby determining movement of the one or more objects along the Z-axis.

The method may additionally comprise, after the performing of the blob detection, comparing the plurality of images frame by frame to determine movement of the one or more objects along an X-axis extending left to right in the field of view, and to determine movement of the one or more objects along a Y-axis extending up and down in the field of view.

Therefore, based on the foregoing and continuing description, the subject invention in its various embodiments may comprise one or more of the following features in any non-mutually-exclusive combination:
A system for remote and passive mapping of one or more physical objects in space, the system comprising a plurality of sensors for imaging one or more physical objects and for determining size, distance, and/or motion of the physical objects, thereby producing imaging data for the one or more physical objects, one or more infrared thermal sensors for collecting thermal data for the one or more physical objects, and at least one computer comprising at least one processor, wherein the at least one processor is operatively connected to at least one non-transitory, computer readable medium having computer-executable instructions stored thereon, wherein, when executed by the at least one processor, the computer executable instructions carry out a set of steps;
The set of steps comprising combining the imaging data and the thermal data to generate one or more three-dimensional (3D) maps of the one or more physical objects;
The plurality of sensors comprising visual spectrum electro-optical sensors;
The one or more thermal sensors generating inputs to a plurality of algorithms for filtering out background noise from the imaging data;
The plurality of algorithms comprising blob and edge detection algorithms and/or contrast algorithms;
The at least one processor executing one or more of the plurality of algorithms;
The set of steps further comprising processing the imaging data in order to ascertain guidance, navigation, thermal anomalies, and/or control ephemera of the one or more physical objects;
The one or more 3D maps comprising one or more overlays that display the imaging data and/or the thermal data;
The thermal data comprising location and distribution of internal thermal sources within the one or more physical objects;
The set of steps further comprising using the imaging data and/or the thermal data to generate a digital mesh around the one or more physical objects;
The set of steps further comprising using the digital mesh to generate thermal distributions and/or thermodynamic models of the one or more physical objects;
The system interfacing with one or more control systems that provide guidance, navigation, command, control, and/or data handling for one or more objects placed into space and/or orbit;
The imaging data comprising panchromatic spectrum data, red green blue (RGB) data, one or more indicators of the one or more physical objects, pointing and orientation information relating to the one or more physical objects, relative location of the one or more physical objects, and/or depth information representing distances between the system and the one or more physical objects;
The imaging data having a resolution of between 0.5 and 10 cm² per pixel at an operational range of between 2 and 100 m;
The plurality of sensors and the one or more infrared thermal sensors operating in parallel;
The set of steps further comprising using the one or more 3D maps to generate one or more thermal overlays of surfaces of the one or more physical objects;
The set of steps further comprising generating, for each of the one or more physical objects, a simulated object that has six degrees-of-freedom ephemera;
The set of steps further comprising using the one or more thermal overlays to define, for each object in the one or more objects, locations and operational behaviors of internal thermal sources, external thermal sources, and/or modes of heat transfer;
The set of steps further comprising using the one or more 3D maps to generate a thermodynamic and environmental model that is usable to check accuracy of the operational behaviors;
The model comprising a finite element representation of each of the simulated objects;
The set of steps further comprising utilizing the thermal data to generate one or more heat maps of the one or more objects;
The set of steps further comprising utilizing the thermal data to determine existence and/or position of one or more thermal anomalies underneath a surface of the one or more physical objects;
The set of steps further comprising comparing the thermal data to expected thermal properties of the one or more physical objects;
The set of steps further comprising identifying thermal abnormalities in the one or more physical objects;
The set of steps further comprising diagnosing the thermal abnormalities using, at least in part, the imaging data;
The imaging data comprising one or more indicators of the one or more physical objects, pointing and orientation information relating to the one or more physical objects, relative location of the one or more physical objects, and/or depth information representing distances between the system and the one or more physical objects;
A system for remote and passive mapping of one or more physical objects in space, the system comprising a plurality of lenses that provide a field of view for a user, an infrared sensor that measures infrared light radiating from one or more objects within the field of view, a plurality of visible spectrum sensors that measure visible light and radiation from the one or more objects within the field of view, one or more electronic circuits and/or computer processors that process data provided by both the infrared sensor and the plurality of visible spectrum sensors, thereby generating information for a user, and a viewing area that displays the information to the user;
The information comprising a visual image of the field of view and a thermal image of the field of view;
The one or more electronic circuits and/or computer processors analyzing the data to determine, within a body-centric reference frame, six degree-of-freedom orientation and navigation vectors for the one or more physical objects;
A method for mapping one or more objects in a field of view, the method comprising collecting a plurality of images of one or more objects in a field of view, performing infrared filtering of the plurality of images, performing blob detection of the plurality of images, performing a visible spectrum object offset comparison of the plurality of images, determining one or more distances between the one or more objects, determining one or more sizes of the one or more objects, and processing the one or more distances and the one or more sizes to determine location and displacement of the one or more objects along a Z-axis extending towards and away the field of view, thereby determining movement of the one or more objects along the Z-axis;
The plurality of images comprising one or more images in the visible portion of the electromagnetic spectrum and one or more images in the infrared portion of the electromagnetic spectrum; and
The method further comprising, after the performing of the blob detection, comparing the plurality of images frame by frame to determine movement of the one or more objects along an X-axis extending left to right in the field of view, and to determine movement of the one or more objects along a Y-axis extending up and down in the field of view.

These and further and other objects and features of the invention are apparent in the disclosure, which includes the above and ongoing written specification, as well as the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIGS. 1A-1G are depictions of SCOUT-Vision representing various features, including, but not limited to, binocular optics with a large optical aperture and a supplemental thermal sensor, from several views, including perspective (FIGS. 1A-1B), a side (FIG. 1C), an overhead (FIG. 1D), a front (FIG. 1E), and partially exploded (FIGS. 1F-1G) view, according to at least one embodiment of the present disclosure.

FIG. 2 is a flow chart of a process for generating imaging and mapping data on one or more objects in a given field of view, according to at least one embodiment of the present disclosure.

FIG. 3 is a schematic diagram of the operational flow of SCOUT-Vision, according to at least one embodiment of the present disclosure.

FIG. 4 is a flow chart of a process for generating movement information and data on one or more objects in a given field of view, according to at least one embodiment of the present disclosure.

FIG. 5 is a diagram of a process for imaging and mapping one or more objects in a given field of view, according to at least one embodiment of the present disclosure.

FIGS. 6A-6B are sample visible spectrum (FIG. 6A) and thermal (FIG. 6B) images, respectively, according to at least one embodiment of the present disclosure.

FIGS. 7A-7B are diagrams of an imaging and mapping system within an Oversight Visuals and External Reference Satellite (OVER-Sat) (FIG. 7A) and within a larger-scale satellite or system (FIG. 7B).

FIG. 8 is a diagram of a computing system for operating a system for imaging and mapping one or more objects in a given field of view, according to at least one embodiment of the present disclosure.

FIG. 9 is a diagram of one or more computing devices for operating a system for imaging and mapping one or more objects in a given field of view, according to at least one embodiment of the present disclosure.

FIG. 10 is a diagram of a computing device including memory on which an imaging and mapping application is stored, according to at least one embodiment of the present disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, “at least one of A, B, and C” indicates A or B or C or any combination thereof. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

As used herein, ranges are used herein in shorthand, so as to avoid having to list and describe each and every value within the range. Any appropriate value within the range can be selected, where appropriate, as the upper value, lower value, or the terminus of the range.

Unless indicated to the contrary, numerical parameters set forth herein are approximations that can vary depending upon the desired properties sought to be obtained. At the very least, and not as an attempt to limit the application of the doctrine of equivalents to the scope of any claims, each numerical parameter should be construed in light of the number of significant digits and ordinary rounding approaches.

The words “comprise”, “comprises”, and “comprising” are to be interpreted inclusively rather than exclusively. Likewise the terms “include”, “including” and “or” should all be construed to be inclusive, unless such a construction is clearly prohibited from the context. The terms “comprising” or “including” are intended to include embodiments encompassed by the terms “consisting essentially of” and “consisting of”. Similarly, the term “consisting essentially of” is intended to include embodiments encompassed by the term “consisting of”. Although having distinct meanings, the terms “comprising”, “having”, “containing” and “consisting of” may be replaced with one another throughout the description of the invention.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

“Typically” or “optionally” means that the subsequently described event or circumstance may or may not occur, and that the description includes instances where said event or circumstance occurs and instances where it does not.

Wherever the phrase “for example,” “such as,” “including” and the like are used herein, the phrase “and without limitation” is understood to follow unless explicitly stated otherwise.

In general, the word “instructions,” as used herein, refers to logic embodied in hardware or firmware, or to a collection of software units, possibly having entry and exit points, written in a programming language, such as, but not limited to, Python, R, Rust, Go, SWIFT, Objective C, Java, JavaScript, Lua, C, C++, or C#. A software unit may be compiled and linked into an executable program, installed in a dynamic link library, or may be written in an interpreted programming language such as, but not limited to, Python, R, Ruby, JavaScript, or Perl. It will be appreciated that software units may be callable from other units or from themselves, and/or may be invoked in response to detected events or interrupts. Software units configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. Generally, the instructions described herein refer to logical modules that may be combined with other modules or divided into sub-modules despite their physical organization or storage. As used herein, the term “computer” is used in accordance with the full breadth of the term as understood by persons of ordinary skill in the art and includes, without limitation, desktop computers, laptop computers, tablets, servers, mainframe computers, smartphones, handheld computing devices, and the like.

In this disclosure, references are made to users performing certain steps or carrying out certain actions with their client computing devices/platforms. In general, such users and their computing devices are conceptually interchangeable. Therefore, it is to be understood that where an action is shown or described as being performed by a user, in various implementations and/or circumstances the action may be performed entirely by the user's computing device or by the user, using their computing device to a greater or lesser extent (e.g. a user may type out a response or input an action, or may choose from preselected responses or actions generated by the computing device). Similarly, where an action is shown or described as being carried out by a computing device, the action may be performed autonomously by that computing device or with more or less user input, in various circumstances and implementations.

In this disclosure, various implementations of a computer system architecture are possible, including, for instance, thin client (computing device for display and data entry) with fat server (cloud for app software, processing, and database), fat client (app software, processing, and display) with thin server (database), edge-fog-cloud computing, and other possible architectural implementations known in the art.

Generally, embodiments of the present disclosure are directed towards systems, devices, and methods related to mixed stereoscopic imaging and heat mapping in outer space. In particular, the application relates to a passive hyperspectral visual and infrared sensing system used for mixed stereoscopic imaging and heat mapping of objects in outer space.

At least one embodiment comprises a system, referred to herein as “SCOUT-Vision,” in which a multi-sensor package providing remote and passive mapping of physical objects in space, including, but not limited to, depth, surface, and heat mapping. Mapping is represented by one or more overlays, and specific overlays can be selected and/or de-selected through the user interface depending on user preferences. Specifically, thermal mapping may be based on a digital mesh developed from observations of the system, and is used as a frame of reference for inferring internal thermal sources in all three axes (i.e., the X-, Y-, and Z-axis) and distribution across observed objects in the field of view.

SCOUT-Vision also interfaces with other systems and/or devices, such as, for instance, control systems relying upon reference images for guidance, navigation, and control, or on-board command and data handling subsystems. Such interfacing may be achieved through a serial bus or any other interfacing technology and/or devices known in the art in order to produce both a visual image of an object and a thermal overlay, thereby providing thermal mapping in combination with visual spectrum data.

In at least one embodiment, the visual spectrum data includes, but is not limited to, the following data: visual image(s); indicators of points and/or objects of interest within the field of view of the system; pointing and orientation information derived from, among other sources, the relative location of remote objects; orientation information for remote objects of interest; and/or depth information representing distances between the optical system and the remote object of interest as well as distances between discernible thermal sources within observed objects and/or surfaces in multi-faceted objects. Such data is capable of being provided at resolutions of 0.5-10 centimeters squared per pixel in the nominal operational range of 2 km to 100 km in at least one embodiment, with sub-second latency. Depth information can be provided completely passively thanks to binocular vision. The visual spectrum data may also, in at least one embodiment, comprise panchromatic spectrum data and/or red green blue (RGB) imaging data.

In various embodiments, SCOUT-Vision comprises a plurality of sensors to image objects and determine their size, distance, and/or motion. Non-limiting examples of these sensors include visual spectrum electro-optical sensors. In at least one embodiment, the sensors of SCOUT-Vision determine an object's size, distance, and/or motion at a nominal distance of up to 100 kilometers and at frame-rates up to 180 frames per second, using a plurality of methods known in the art, although the system is designed such that future implementation of deep learning-supported frameworks may facilitate and streamline remote sensing and/or object size and shape determination, among other characterization and ephemera.

SCOUT-Vision may further comprise one or more computer processors capable of processing the images gathered by the plurality of sensors in order to ascertain guidance, navigation, and control ephemera of relative objects, such as, for instance, six degree-of-freedom orientation and navigation vectors within a body-centric reference frame, which can then be translated using secondary or tertiary navigation systems to geocentric coordinates. One of skill in the art will appreciate that six degree-of-freedom orientation and navigation vectors within a body-centric reference frame refers to any and all coordinates within a field of view, as well as motion characteristics, including rotation, of any object seen in that field of view. The one or more processors are further capable of exporting some or all of the processing data, including, for instance, the aforementioned orientation and navigation vectors, to other spacecraft subsystems, such as, for example guidance, navigation, and control subsystems, command and data-handling controllers, or data transceivers. Exportation may be achieved through a serial bus or other connection known in the art.

In at least one embodiment, SCOUT-Vision additionally comprises one or more infrared thermal sensors for conducting surface thermal mapping of remote objects. The one or more thermal sensors are capable of generating inputs to various algorithms, including, but not limited to, blob and edge detection algorithms, thereby enabling SCOUT-Vision to filter out background noise from the visible spectrum imaging described above herein.

The aforementioned algorithms, which may also include, for instance, contrast algorithms, are used to define remote object shapes, after which tracking, as well as surface and internal system characterization, can be conducted on them. It should be appreciated that, although the aforementioned algorithms are known in the art, they are being applied within a novel framework of one or more embodiments of the present disclosure.

The internal system characterization referred to above herein is conducted based on a numerical Finite Element Method-derived (FEM) frame of reference, which represents thermal differentials across tracked objects' various surfaces with a discrete resolution. That is, the numerical FEM frame of reference literally uses the collected data to produce a digital mesh around an object of interest with a baseline resolution based on the data. Interpolation to more refined thermal distributions and thermodynamic models can then be run using the digital mesh. Over a period of time, these thermal observations are used to define and predict object behavior using long short-term memory (LSTM) recurrent neural network architecture-based deep learning integration of the mixed observational datasets. This process has been uniquely developed and trained for space thermodynamic and related datasets using ground-based and simulated space system thermodynamic testing. It should be appreciated that the aforementioned process is novel, at least in its implementation and application with respect to one or more embodiments of the present disclosure. The LSTM framework and physically-informed nature of the analysis provides the system with a closed-loop recurrent boundary layer conditioning framework providing more efficient parameterization of thermal sources based on the selectively framed context clues which the model is not unilaterally biased by.

The various algorithms and neural networks discussed above may be executed by one or more computer processors, including, but not limited to, the one or more computer processors described above herein that are capable of processing the images gathered by the plurality of sensors.

It should therefore be appreciated that at least some of the embodiments of the disclosure enable autonomous analysis, ranging, and/or characterization of observed objects. Specifically, SCOUT-Vision provides parallel operation of both thermal optics and stereoscopic visual spectrum optics. As a result, various embodiments of SCOUT-Vision provide more than a thermal map and enable remote sensing, autonomous diagnostics, and/or autonomous navigation in space.

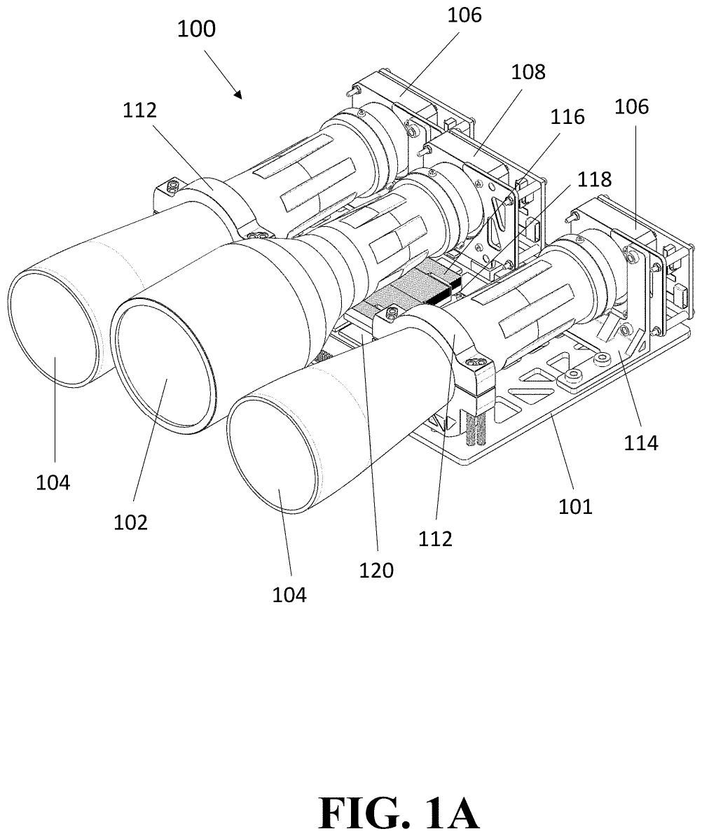

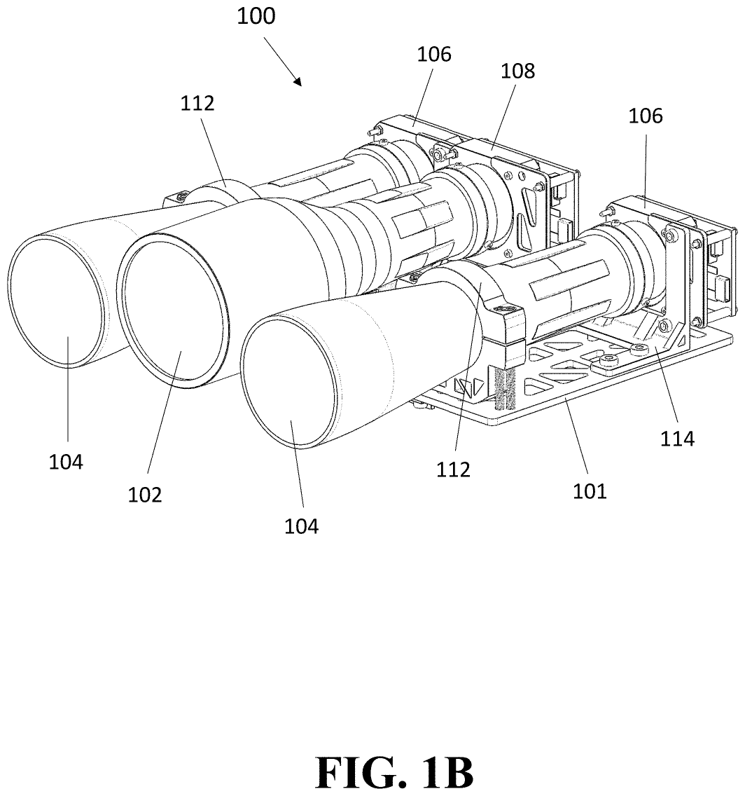

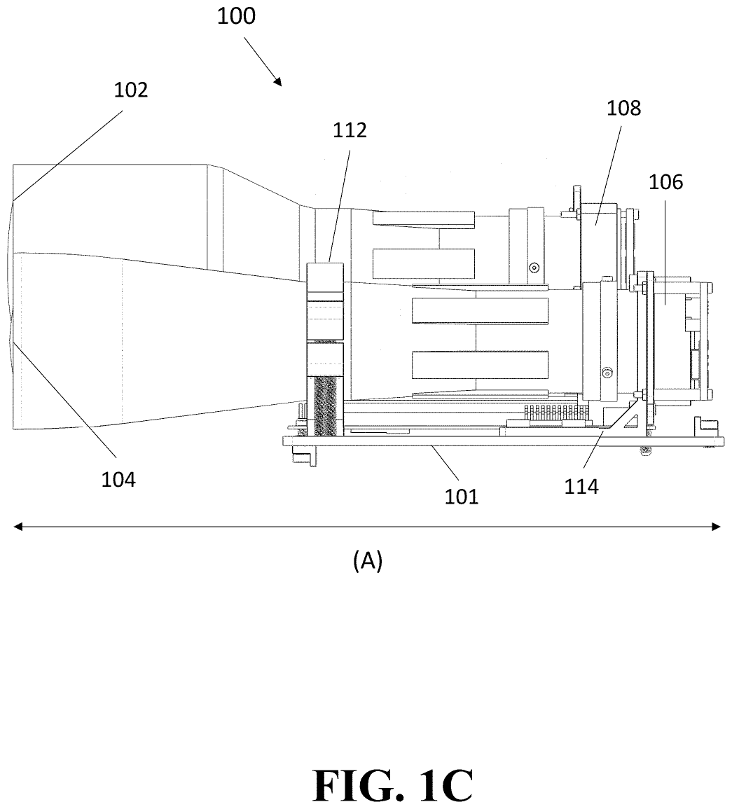

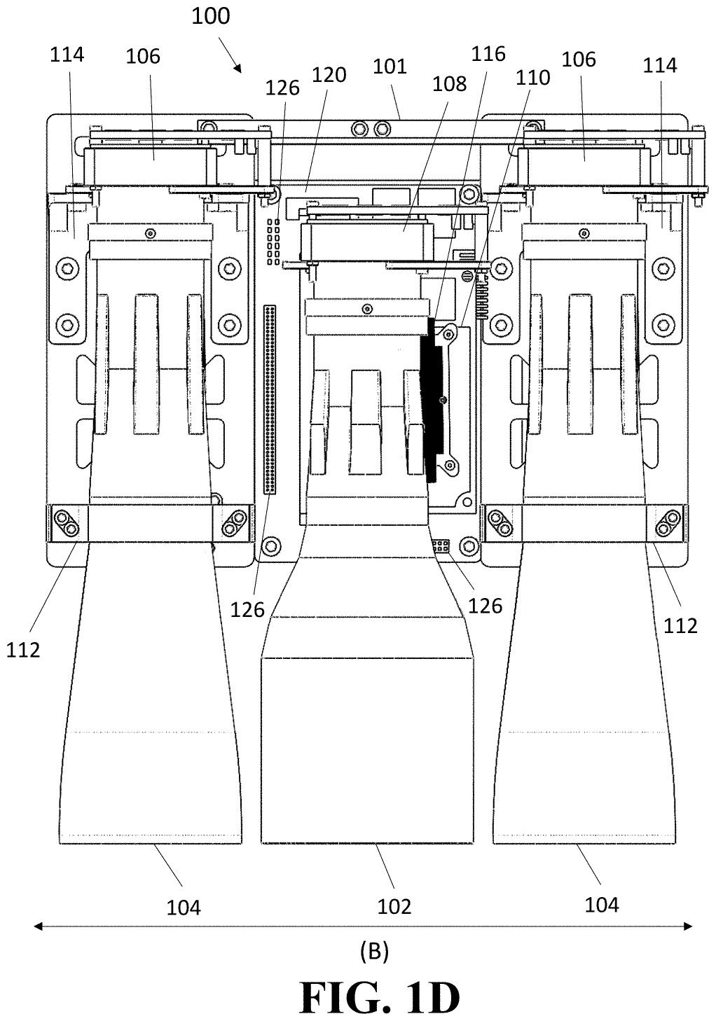

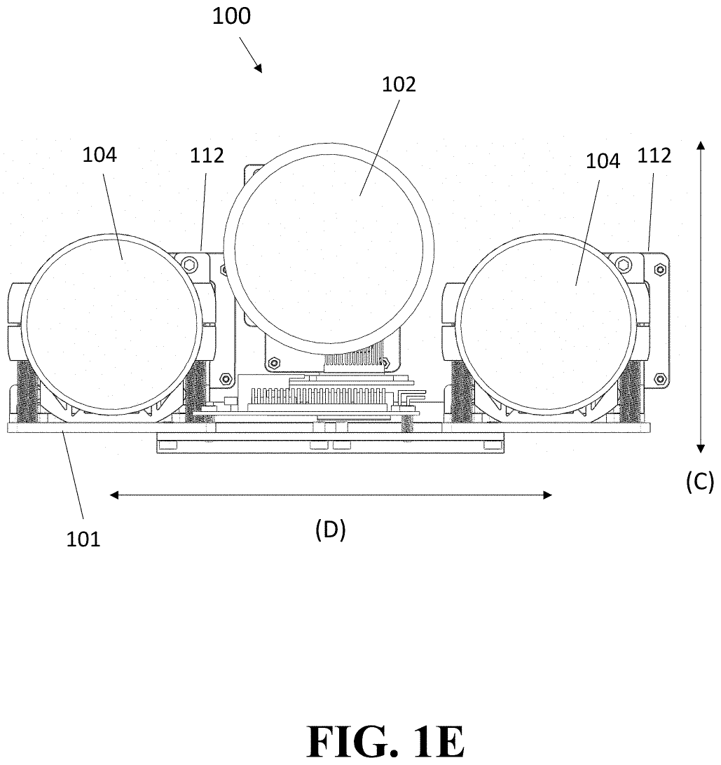

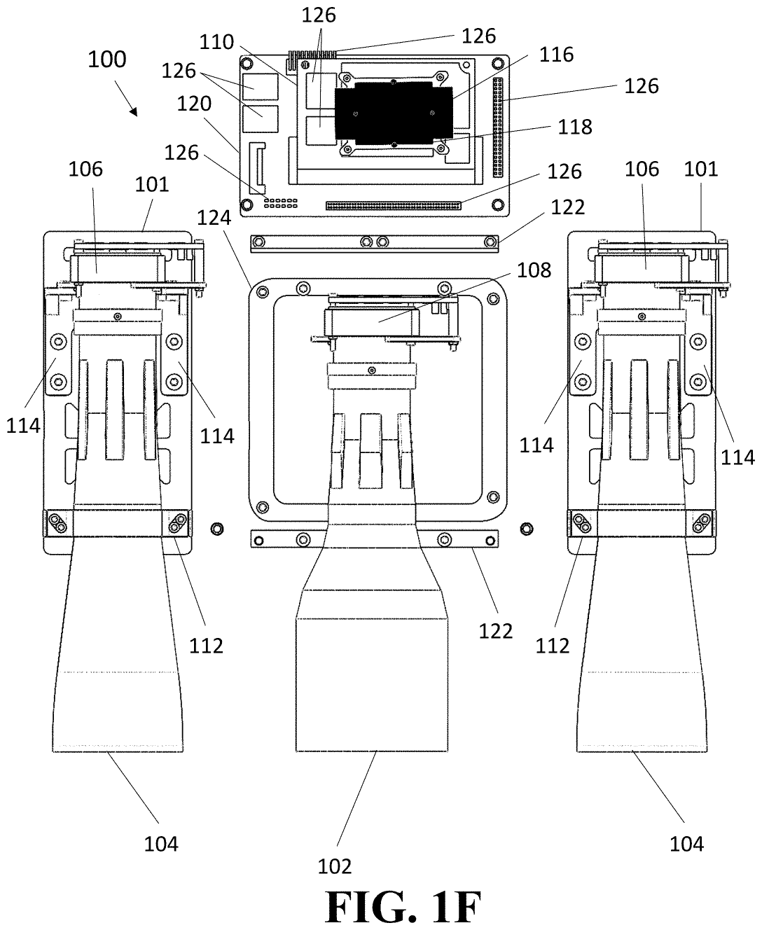

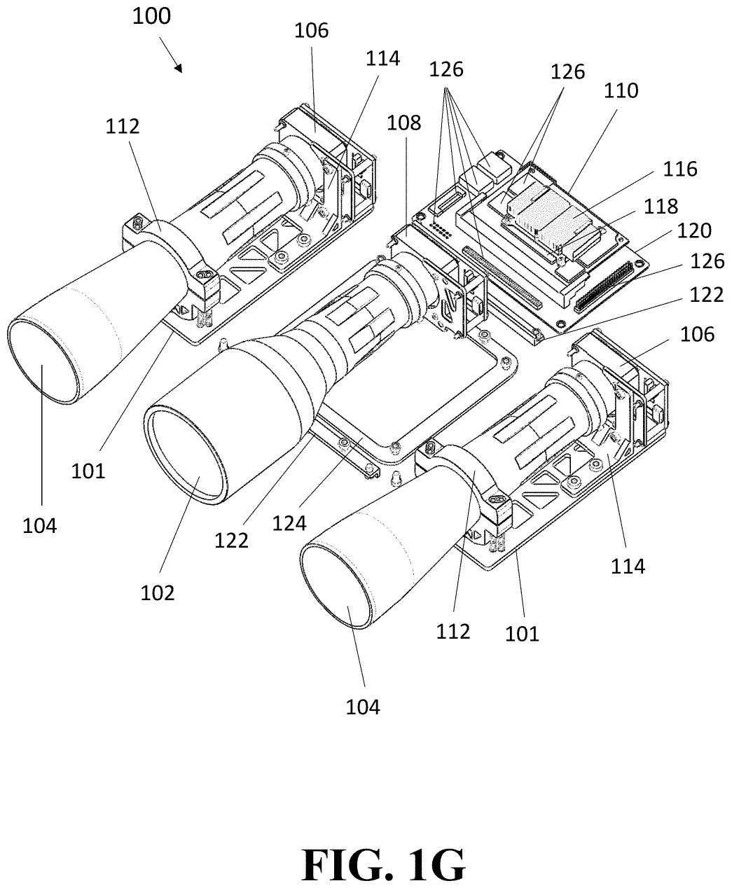

Turning now to FIGS. 1A-1G, diagrams of an embodiment of SCOUT-Vision from various views are shown. FIGS. 1A-1G depict external perspective (FIGS. 1A-1B), side (FIG. 1C), overhead (FIG. 1D), front (FIG. 1E), and partially exploded (FIGS. 1F-1G) views of a SCOUT-Vision system 100 that comprises an infrared lens 102 and two visible light optical lenses 104. The lenses are mounted to a mounting or fitment 101. One or more of the lenses are stabilized on the fitment via lens stabilizing fixtures 112. It should be appreciated that each of the lenses (e.g., the infrared lens 102 and the two visible light optical lenses 104) can be arranged in various positions and/or arrangements, including positions other than those shown in the figures. Specifically, the distance between each of the lenses can be adjusted, and each of the lenses can be detached from the mounting or fitment (e.g., fitment 101).

Each of the aforementioned lenses is physically and/or operatively connected to a sensor. Specifically, the infrared lens 102 is connected to an infrared (IR) sensor 108, while each of the two visible light optical lenses 104 is connected to a visible spectrum and/or red-green-blue (RGB) sensor 106. The sensors are mounted to the fitment 101 via sensor mounting fixtures 114. One or more electronic circuits and/or computer processors 110 are also present for operating one or more portions of the system 100. A heat sink 116 is also present, which is physically associated with a computer processor 118 on a circuit board 120. It should be appreciated that the circuit board 120 may contain one or more chips, ports, and/or, electronic circuits 126, and the like that are known in the art, as well as memory containing programmed instructions. Additionally, with particular reference to FIGS. 1F and 1G, connecting fixtures 122 connect the infrared lens 102 and IR sensor 108 with both of the visible light optical lenses 104 and visible spectrum and/or red-green-blue (RGB) sensors 106, while bracket 124 is provided for integration into a satellite (e.g., CubeSat).

In operation, the lenses 104 provide a field of view for the user, and infrared sensor 108 measures infrared light radiating from objects within the field of view. The system 100 may also incorporate and/or be associated with various additional optics and sensors known in the art and not shown in the figures. Thus, information about objects in the field of view, including, for instance, physical data, thermal data, and/or multispectral imaging, can be relayed electronically to the user.

A skilled artisan will recognize that a range of sizes of system 100 are possible. As non-limiting examples, the length (A) may be 192.5 mm, the width (B) may be 175 mm, and the height (C) may be 60 mm. Additionally, the distance (D) between the two visible light optical lenses 104 may be 115 mm.

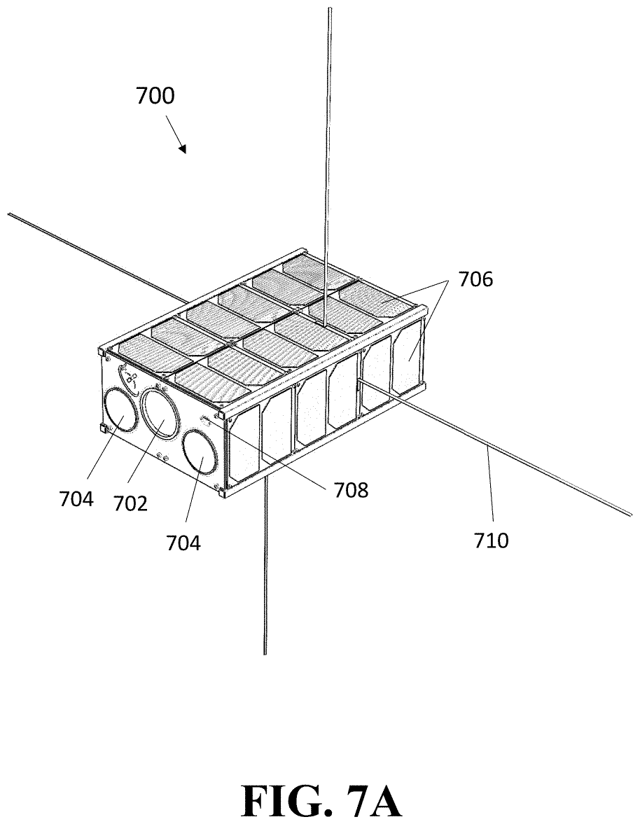

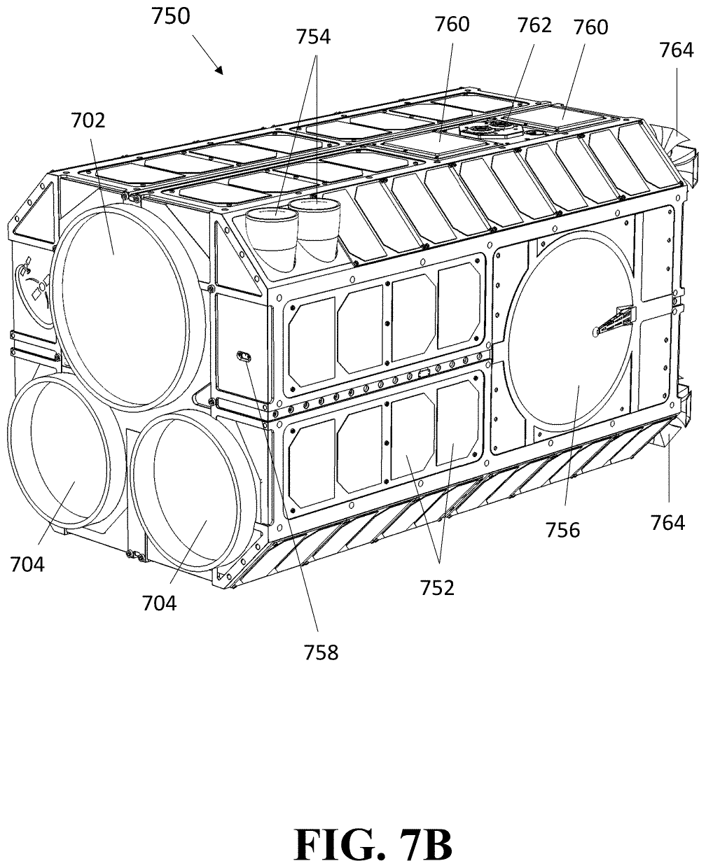

It should be appreciated that SCOUT-Vision, at least in some embodiments, may be utilized within the context of satellites, spacecraft, or other objects placed into space or into orbit. This is shown in further detail herein with reference to FIGS. 7A-7B.

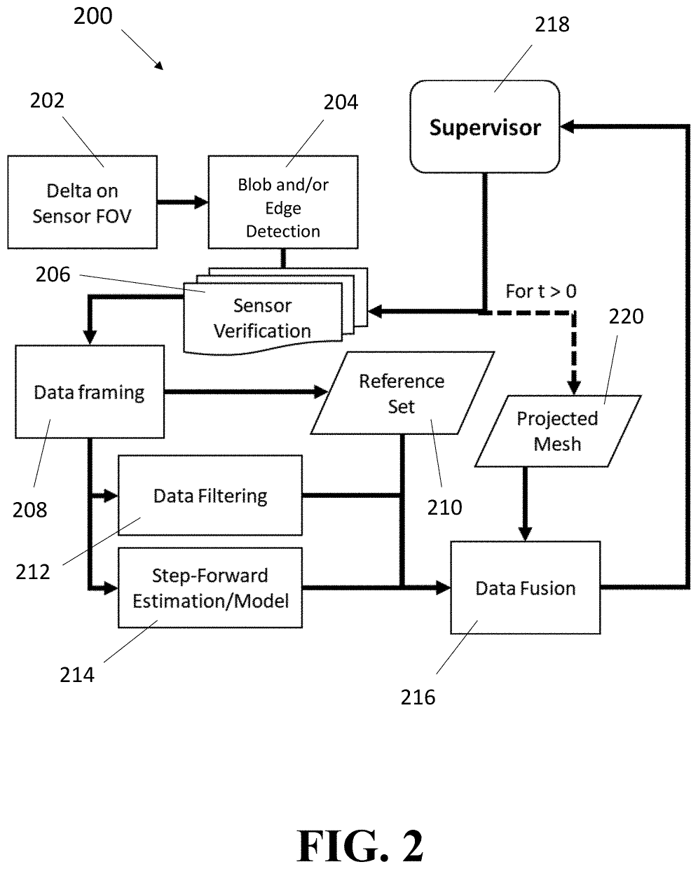

Turning now to FIG. 2, a process 200 of using an imaging and mapping system, such as, for instance, SCOUT-Vision, to generate imaging and mapping data of detected objects in a field of view is shown. As a general overview of the process, detection of objects by a plurality of sensors is followed by an internal verification process to eliminate false positives and radiation-based noise in the sensors. The data collected by the sensors is translated into a projected mesh through a process known to those familiar with the art, which produces baseline references for future data acquisition by the system conditioned by, among other techniques, Kalman filters developed on the ground and refined during operations. The projected mesh is then used for thermal mapping and definition of internal thermal characteristics of the system.

First, one or more sensors collect data on objects in a given field of view at step 202. Such sensors may include, for instance, visible spectrum sensors and/or infrared sensors. The sensors may supply data including, but not limited to, one or more visual images, levels of emitted and/or reflected infrared radiation, levels of emitted and/or thermal radiation, and the like. The data is then used for blob and/or edge detection at step 204. The step of blob detection is a common method known in the art to find adjacent pixels of a similar intensity as an initial step to identify objects in the field of view. Additionally, sensor verification can occur at step 206 to ensure the one or more sensors are obtaining accurate and relevant data. Framing and refining of the collected data then occurs at step 208, which provides a common frame of reference for readings, wherein one or more portions of the data can be used to create a reference set at step 210, based on verification of this frame of reference and the validation of the collected reference state. Such a reference set may be used as comparison data for the purposes of evaluating future collected data sets. After framing, the data collected from the one or more sensors can also be filtered at step 212 as part of data analysis for improved data quality, which can then produce a step-forward estimation or model at step 214 to be used for facilitating the framing process in future process iterations. The aforementioned filtering process may be, for instance, a Kalman filter-based process known to those of skill in the art. Subsequently, the data is combined at step 216 and funneled through a supervisor, which is a processor validating the framing, filtering, and fusion processes, and then combining the results at step 218 in order to create a representative projected mesh of the observed object at step 220. As stated above herein, the projected mesh is then used for thermal mapping and definition of internal thermal characteristics of the system.

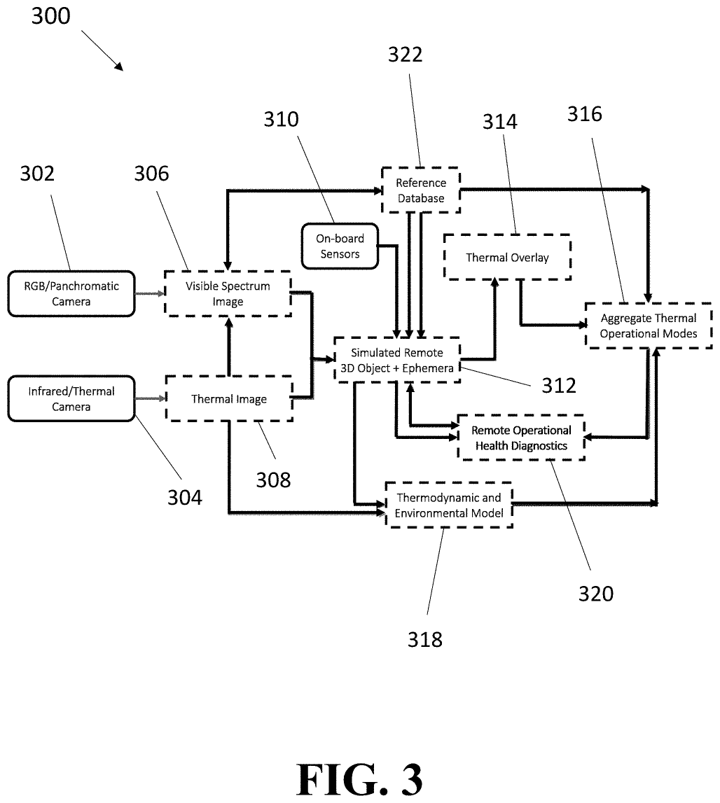

Turning now to FIG. 3, a schematic diagram of the operation of SCOUT-Vision is shown. This operation 300 begins with the RGB/panochromatic camera 302 and the infrared/thermal camera 304. SCOUT-Vision, in at least one embodiment, comprises both such cameras as part of the imaging system. The RGB/panochromatic camera 302 produces a visible spectrum image 306, while the infrared/thermal camera 304 produces a thermal image 308. These two images are combined, with information from on-board sensors 310, to produce a 3D representation 312 of target objects in the field of view. This 3D representation 312 can then be used to produce thermal overlays 314 of each object's respective surfaces. It should therefore be appreciated that SCOUT-Vision is capable of utilizing computer vision techniques which leverage the benefits to thermal vision of a vacuum environment, such as that of outer space, to produce a simulated remote 3D object that includes six degree-of-freedom, completely passive and remote, ephemera. Thus, SCOUT-Vision's combination of cameras, in addition to the on-board sensors, is implemented to produce six degrees-of-freedom ephemera and a 360-degree coverage of target objects.

The thermal overlays 314 can themselves be used to define the coordinates and operational behaviors 316 of internal and external thermal sources and modes of heat transfer, which therefore define the coordinates and operational behaviors of electronic systems within observed systems by tracing thermal losses in system corresponding electrical activity. The observational behaviors 316 may also encompass some or all of the behaviors of other thermal operational modes, thereby resulting in an aggregate view of the thermal characteristics of target objects. Further, the 3D representation 312 can be used to produce a thermodynamic and environmental model 318 that is used as a reference to check the accuracy of the thermal operational behaviors 316. This model includes a finite element representation of the simulated remote 3D object, which may be, for instance, a tetrahedral element-based mesh. SCOUT-Vision is therefore capable of obtaining images of the external surfaces of one or more target objects and analyzing these images and surfaces in order to determine the physical coordinates of internal heat sources based on thermal patterns on the surfaces. SCOUT-Vision is further able to conduct a non-invasive, discerning internal analysis of unprecedented variable isolation at a nominal resolution of <1 cm² per pixel, given enough time to gather data.

Information from both the 3D representation 312 and the operational behaviors 316 of internal thermal sources can further be used to produce unique data sets representing remote operational health diagnostics 320. SCOUT-Vision is therefore able to recognize variance in system operations due to anomalies or activities correlated with previously-observed operations, as well as projected extrapolated capabilities based on a reference database 322 of objects and on identification data available to inspection vehicles, which can be guided to conduct remote observations of assets, including, but not limited to, health check-ups, inspections, detection of any anomalies, and other diagnostics. This reference database 322 also provides a reference for the systems of SCOUT-Vision to check the 3D representation 312 against objects in the database to ensure accuracy of the representation.

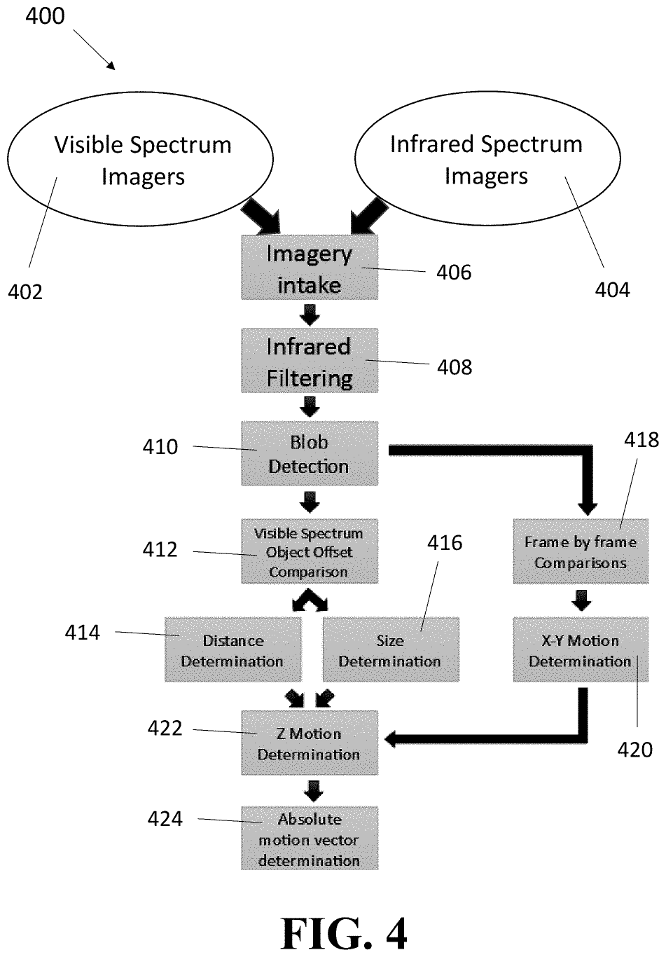

FIG. 4 is a flow chart of a process 400 that uses an imaging and mapping system, such as, for instance, SCOUT-Vision, to generate data relating to the motion of one or more objects in a relevant field of view. First, various imagers, including, for example, visible spectrum imagers 402 and infrared spectrum imagers 404, collect a plurality of images of objects in the field of view. The visible spectrum imagers collect one or more images in the visible portion of the electromagnetic spectrum, while the infrared spectrum imagers collect one or more images in the infrared portion of the electromagnetic spectrum. The system then intakes these images at step 406 and performs infrared filtering at step 408. Blob detection occurs subsequently at step 410. The images are then subject to visible spectrum object offset comparison at step 412, which, through parallax and computational methods known in the art, enables both distance determination (i.e., determination of the distance between objects in the field of view as well as between the vision system and objects in the field of view) at step 414, and size determination (i.e., determination of the size of objects in the field of view) at step 416. Both distance determination and size determination data are processed to determine location and displacement along the Z-axis at step 422, which determines the movement of objects in the field of view along a Z-axis (i.e., depth, or either toward or away from the user).

Additionally, after blob detection, frame by frame comparisons of the images are performed at step 418 in order to determine X-Y motion at step 420. X-Y motion determination refers to the determination of movement of objects in the field of view along the X-axis (i.e., left-right movement within the field of view) and the Y-axis (i.e., up-down movement within the field of view). Such X-Y motion determination is then used, along with the distance determination data and size determination data recited above herein, for Z-motion determination at step 422. Once Z-motion is determined, a determination of absolute motion vectors can be achieved at step 424. This step enables determination of various vectors that tell a user additional information about the movement of objects in the field of view, including, for instance, the speed of such movement.

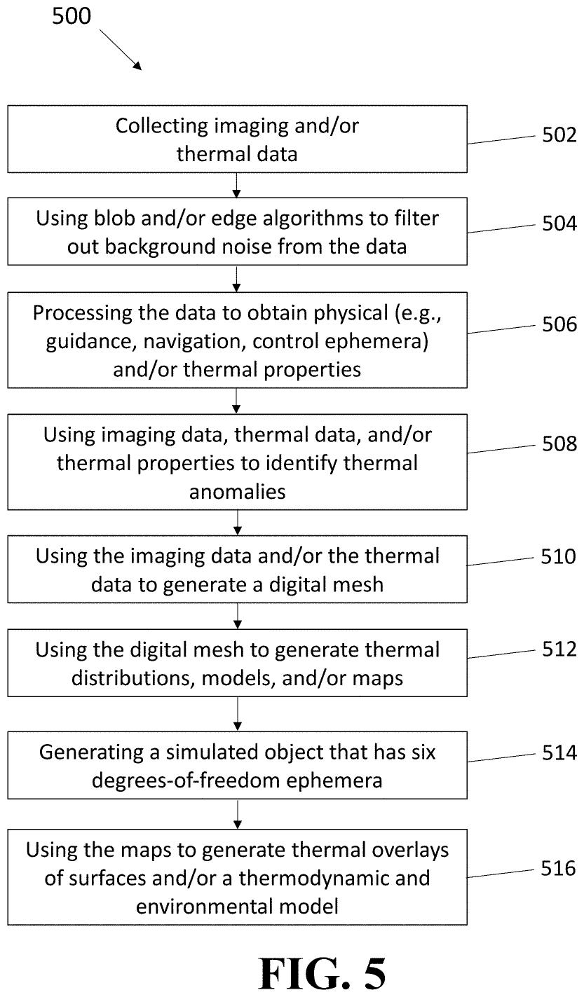

Turning now to FIG. 5, a method 500 is shown for imaging and/or mapping one or more physical objects, according to at least one embodiment of the disclosure. One or more systems described herein, including SCOUT-Vision, may perform one or more steps of the method 500. At step 502, imaging and/or thermal data is collected. The imaging and/or thermal data may stem, at least in part, from visible spectrum images (e.g., image 306) and/or thermal images (e.g., image 308). Further, the imaging and/or thermal data may be collected by one or more infrared lenses (e.g., lens 102), one or more infrared sensors (e.g., sensor 108), one or more optical lenses (e.g., lenses 104), and/or one or more visible spectrum and/or red-green-blue (RGB) sensors (e.g., sensor 106). At step 504, one or more blob and/or edge detection algorithms are used to filter out background noise from the data. At step 506, the data is processed to obtain physical and/or thermal properties of the one or more objects. As described herein, the physical properties may include, for example, guidance, navigation, and control ephemera of relative objects, such as, for instance, six degree-of-freedom orientation and navigation vectors within a body-centric reference frame, which can then be translated using secondary or tertiary navigation systems to geocentric coordinates.

At step 508, the imaging data, the thermal data and/or thermal properties (e.g., expected thermal properties) of the one or more objects can be used to identify thermal abnormalities of the one or more objects. For example, the thermal data can be used to generate one or more heat maps, or to determine the existence and/or position of one or more thermal anomalies underneath a surface of the one or more objects. The thermal data can also be compared to expected thermal properties of the one or more objects, leading to identification of the thermal abnormalities. Thermal abnormalities may also be diagnosed by using, at least in part, information from the imaging data. Such information may include, for example, one or more indicators of the one or more objects, pointing and orientation information relating to the one or more objects, relative location of the one or more objects, and/or depth information representing distances between the imaging and/or mapping system (e.g., system 100) and the one or more objects.

At step 510, the imaging data and/or thermal data can be used to generate a digital mesh. As described herein, interpolation to more refined thermal distributions and thermodynamic models can then be run using the digital mesh. The digital mesh can then be used, at step 512, to generate thermal distributions, models (e.g., thermodynamic models), and/or maps (e.g., 3D maps such as 3D representation 312) of the one or more objects.

At step 514, a simulated object for each of the one or more objects is generated. The simulated object has six degrees-of-freedom ephemera, as described herein.

Finally, at step 516, one or more of the aforementioned maps is used to generate thermal overlays of surfaces of the one or more objects and/or a thermodynamic and environmental model (e.g., model 318).

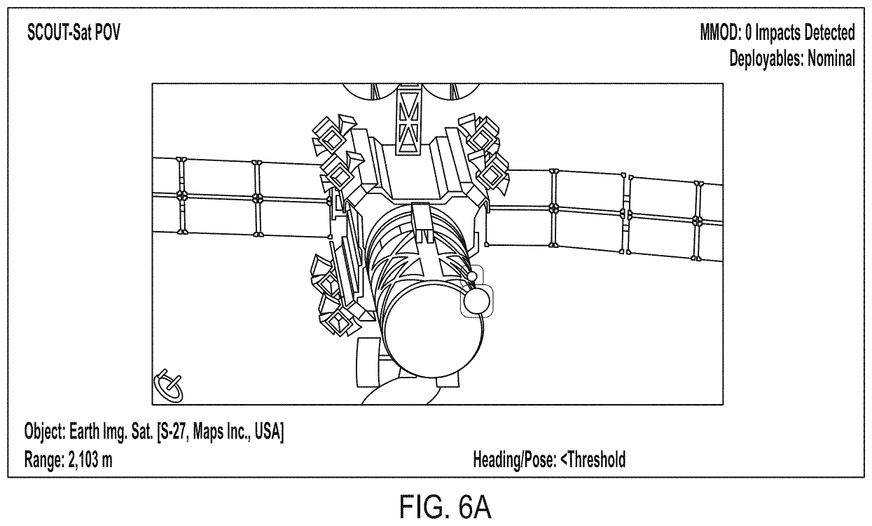

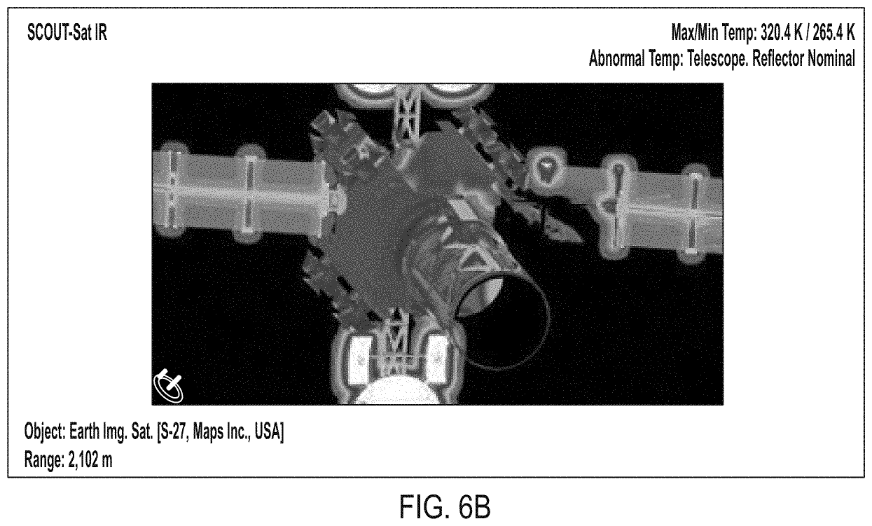

Turning now to FIGS. 6A-6B, sample images taken from an imaging and mapping system (e.g., SCOUT-VISION) are shown. FIG. 6A shows a visible spectrum image of a field of view of the system, while FIG. 6B shows an infrared image of the same field of view.

At least one embodiment of the imaging and mapping system disclosed herein, such as, for instance, SCOUT-Vision, utilizes edge computing leveraging artificial intelligence (AI)-backed cataloguing. Such cataloguing provides a framework for feature and mesh extraction from one or more objects observed in the field of view. One of skill in the art will recognize that (1) known objects may have their point clouds projected over multispectral imagery to determine hot spots on the mesh, and (2) unknown objects can undergo a point cloud extraction via depth-mapped stereo vision feature segmentation, after which they can be mapped multispectrally. However, such a skilled artisan will appreciate that the aforementioned is usually performed by ground-based systems or methods, rather than by an imaging and mapping system deployed in outer space.

Further, as mentioned above, embodiments of the disclosure may be incorporated into one or more different types of satellites (e.g., a 3U Cube Sat). Thus, in at least one embodiment, a multispectral system can be incorporated into a 6U Cube Sat. FIGS. 7A and 7B display example embodiments of the system disclosed herein deployed in an Oversight Visuals and External Reference Satellite (OVER-Sat) (FIG. 7A) and in a larger-scale satellite (FIG. 7B). One of skill in the art will therefore appreciate that embodiments of the system disclosed herein, such as, for instance, the system shown in FIG. 1, may be incorporated into satellites or other similar space objects of varying sizes, dimensions, and/or form factors. Generally, in any such system, for commensurate resolution on the optical and infrared lenses and/or sensors, the optics require a larger aperture and a longer range to match the decreased resolution on infrared (IR) sensors (specifically, e.g., medium wavelength infrared (MWIR) and long wavelength infrared (LWIR) ranges).

Thus, in FIG. 7A, infrared lens 702 and optical lenses 704 are shown on the exterior of a satellite (e.g., OVER-Sat) 700 that is powered, at least in part, by solar panels 706. A sun sensor 708 on the exterior is also shown, as are whip antennas 710. Similarly, in FIG. 7B, infrared lens 702 and optical lenses 704 are shown on the exterior of a larger-scale satellite 750 that is powered, at least in part, by solar panels 752. Additional lenses 754, which may also be optical lenses, are positioned so as to point orthogonally to the infrared lens 702 and optical lenses 704. Also shown on the exterior are dish antenna 756, sun sensor 758, patch antennas 760, refueling port 762, and reaction control system (RCS) thrusters 764. It should be appreciated that, in at least some embodiments, infrared lens 702 is infrared lens 102, and optical lenses 704 are optical lenses 104. It should further be appreciated that, in at least some embodiments, the sun sensor 758 is the same as sun sensor 708.

Embodiments of the present disclosure may also include one or more sets of instructions for executing any of the methods, processes, steps, data and/or image generation, data and/or image analysis, and functions described above herein. Such instructions can be stored on at least one non-transitory, computer readable medium so that, when at least one computer processor is operatively connected to the at least one non-transitory, computer readable medium, the instructions execute one or more of the aforementioned methods, processes, steps, data and/or image generation, data and/or image analysis, and functions. The aforementioned at least one computer processor may be or include, in at least some embodiments, processor 118.

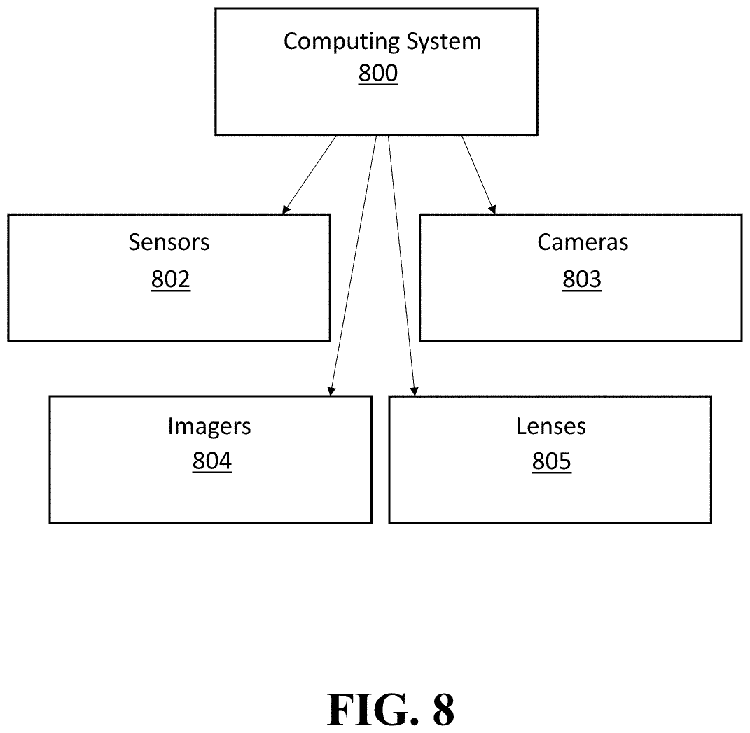

Turning now to FIG. 8, a block diagram is shown of a computing system 800 for controlling and/or operating one or more embodiments of the disclosure described above herein, such as, for instance, any of the imaging and/or mapping systems depicted in one or more of the previous figures. Thus, the computing system 800 may control, monitor, and/or optimize performance of: sensors 802 (e.g., visible spectrum sensors and/or infrared sensors described with reference to FIG. 2, the sensors 310, etc.), cameras 803 (e.g., the RGB/panochromatic camera 302 and/or an infrared/thermal camera 304), imagers 804 (e.g., visible spectrum imagers 402 and infrared spectrum imagers 404), and/or lenses 805 (e.g., the infrared lens 502 and/or the two visible light optical lenses 503). As mentioned above herein, the computing system may include one or more controls and/or operations using AI (e.g., edge computing leveraging AI-backed cataloguing).

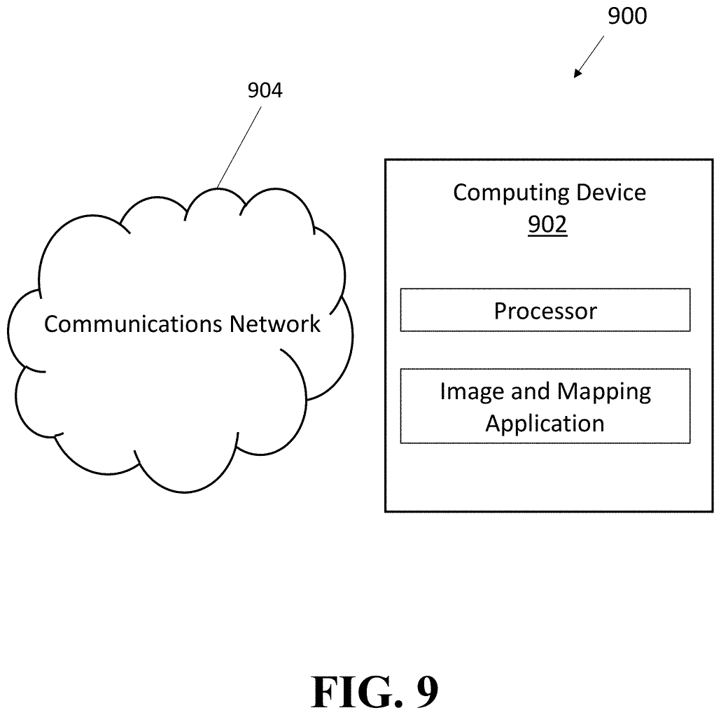

Turning now to FIG. 9, a block diagram is shown of a computing system 900 for controlling and/or operating an imaging and/or mapping system, according to an example embodiment. Thus, the computing system 900 may control, for instance, the sensors 802, the cameras 803, the imagers 804, and/or the lenses 805, all shown in FIG. 8. The system 900 comprises one or more computing devices 902 that may be in space (e.g., on, or a part of, a satellite) and/or on the ground. For example, the one or more computing devices may be distributed with one or more portions or aspects thereof on the ground, and other portions on a satellite, with communications, optics, and/or electronics linking the ground-based portions and the satellite-based portions. The one or more computing devices 902 may execute one or more imaging and/or mapping applications to control and/or operate one or more imaging and/or mapping applications and/or processes, or portions thereof. Such applications may be driven, in whole or in part, by AI. The applications can further be capable of scheduled or triggered communications or commands when various events occur (e.g., a specific type or number of space objects entering the field of view, sensing and/or determination of heat anomalies related to one or more objects in the field of view, completion of optical and/or thermal imaging of one of more objects in the field of view).

The one or more computing devices 902 can be used to store acquired imaging and/or thermal data of one or more objects in the field of view of the imaging and/or mapping system, as well as other data in memory and/or a database. The memory may be communicatively coupled to one or more hardware processing devices which are capable of utilizing AI. Such data may include, as mentioned above herein, one or more visual images, one or more thermal images, one or more heat maps, levels of emitted and/or reflected infrared radiation, levels of emitted and/or thermal radiation, physical coordinates of internal heat sources, distance determination (i.e., determination of the distance between objects in the field of view as well as between the vision system and objects in the field of view), size determination (i.e., determination of the size of objects in the field of view), movement of objects in the field of view along a Z-axis (i.e., depth, or either toward or away from the user), and the like.

The one or more computing devices 902 may further be connected to a communications network 904, which can be the Internet, an intranet, or another wired or wireless communication network. For example, the communication network 904 may include a Mobile Communications (GSM) network, a code division multiple access (CDMA) network, 3rd Generation Partnership Project (GPP) network, an Internet Protocol (IP) network, a wireless application protocol (WAP) network, a Wi-Fi network, a satellite communications network, or an IEEE 802.11 standards network, as well as various communications thereof. Other conventional and/or later developed wired and wireless networks may also be used.

The one or more computing devices 902 include at least one processor (which may be or include, e.g., processor 118) to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of a performance optimization application. In addition, the one or more computing devices 902 further include at least one communications interface to transmit and receive communications, messages, and/or signals.

Thus, information processed by the one or more computing devices 902, or the applications executed thereon, may be sent to another computing device, such as a remote computing device, via the communication network 904. As a non-limiting example, information relating to visual and/or thermal characteristics of one or more objects in the field of view of an imaging and/or mapping system may be sent to one or more other computing devices (e.g., computing devices that control one or more spacecraft subsystems, such as, for instance, guidance, navigation, and control subsystems, command and data-handling controllers, or data transceivers).

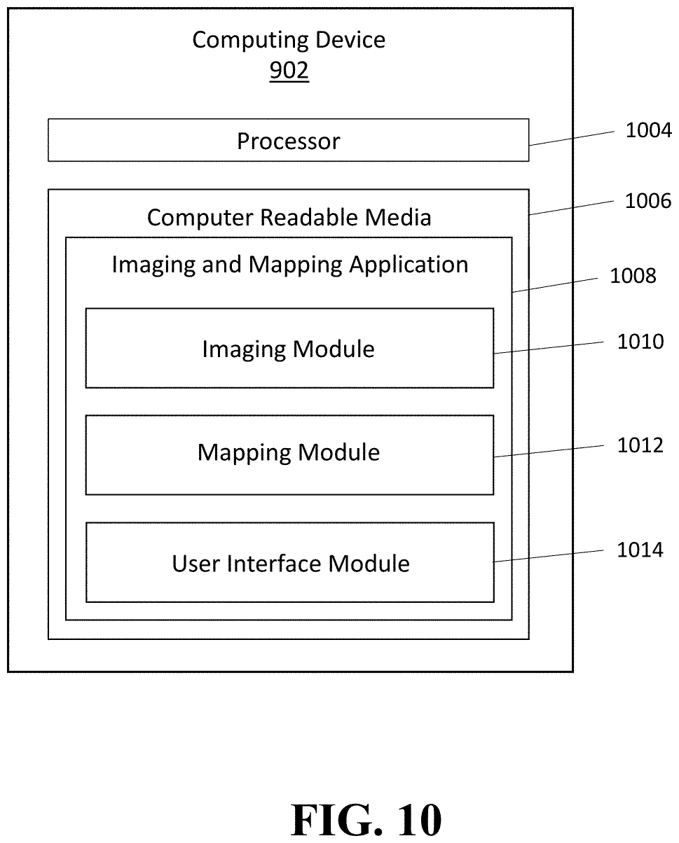

FIG. 10 illustrates a block diagram of a computing device 902 according to an example embodiment. The computing device 902 includes computer readable media (CRM) 1006 in memory on which an imaging and mapping application 1008 or other user interface or application is stored. The computer readable media may include volatile media, nonvolatile media, removable media, non-removable media, and/or another available medium that can be accessed by the processor 1004. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

As stated above herein, such imaging and mapping application 1008 includes an imaging module 1010 and a mapping module 1012. The imaging module 1010 is operable to obtain visual and/or thermal data and/or images of one or more objects within a field of view of an imaging and/or mapping system. The mapping module 1012 is operable to generate data (e.g., a projected mesh) to generate a thermal map, and to define thermal characteristics of, the one or more objects. The imaging module and/or the mapping module are operable to perform further functions described herein, including, for instance, one or more of the functions described in FIGS. 3-4. One or more of these modules may be driven, in whole or in part, by AI.

Using a local high-speed network, the computing device 902 may receive the aforementioned data in near real time from, e.g., the sensors 802, the cameras 803, the imagers 804, and/or the lenses 805, and generate calculations relating to imaging and/or thermal mapping of one or more objects. These calculations may be executed by one or more algorithms within the imaging and mapping application 1008 or other stored applications.

Measured or calculated data may be monitored to generate an event and an alert if something is out of range (e.g., errors related to the optical or infrared lenses, impending approach of one or more space objects, and the like). Such alerts may be sent in real-time or near real-time using an existing uplink or dedicated link. The alerts may be sent using email, SMS, push notification, or using an online messaging platform to end users and computing devices.

The imaging and mapping application 1008 may provide data visualization using a user interface module 1014 for displaying a user interface on a display device. As an example, the user interface module 1014 generates a native and/or web-based graphical user interface (GUI) that accepts input and provides output viewed by users of the computing device 902. The computing device 902 may provide real-time automatically and dynamically refreshed information on the functioning of one or more portions of the imaging and/or mapping system, or on the functioning of one or more imaging and/or mapping processes. The user interface module 1014 may send data to other modules of the imaging and mapping application 1008 of the computing device 902, and retrieve data from other modules of the imaging and mapping application 1008 of the computing device 902 asynchronously without interfering with the display and behavior of the user interface displayed by the computing device 902.

These and other objectives and features of the invention are apparent in the disclosure, which includes the above and ongoing written specification.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

We claim:

1. A system for remote and passive mapping of one or more physical objects in space, the system comprising:
a plurality of sensors for imaging one or more physical objects and for determining size, distance, and/or motion of the physical objects, thereby producing imaging data for the one or more physical objects;
one or more infrared thermal sensors for collecting thermal data for the one or more physical objects; and
at least one computer comprising at least one processor, wherein the at least one processor is operatively connected to at least one non-transitory, computer readable medium having computer-executable instructions stored thereon, wherein, when executed by the at least one processor, the computer executable instructions carry out a set of steps comprising:
combining the imaging data and the thermal data to generate one or more three-dimensional (3D) maps of the one or more physical objects.

2. The system of claim 1, wherein the plurality of sensors comprises visual spectrum electro-optical sensors.

3. The system of claim 1, wherein the one or more thermal sensors generate inputs to a plurality of algorithms for filtering out background noise from the imaging data, and wherein the plurality of algorithms comprises blob and edge detection algorithms and/or contrast algorithms.

4. The system of claim 3, wherein the at least one processor executes one or more of the plurality of algorithms.

5. The system of claim 1, wherein the set of steps further comprises:
processing the imaging data in order to ascertain guidance, navigation, thermal anomalies, and/or control ephemera of the one or more physical objects.

6. The system of claim 1, wherein the one or more 3D maps comprise one or more overlays that display the imaging data and/or the thermal data.

7. The system of claim 1, wherein the thermal data comprises location and distribution of internal thermal sources within the one or more physical objects.

8. The system of claim 1, wherein the set of steps further comprises:
using the imaging data and/or the thermal data to generate a digital mesh around the one or more physical objects; and
using the digital mesh to generate thermal distributions and/or thermodynamic models of the one or more physical objects.

9. The system of claim 1, wherein the system interfaces with one or more control systems that provide guidance, navigation, command, control, and/or data handling for one or more objects placed into space and/or orbit.

10. The system of claim 1, wherein the imaging data comprises panchromatic spectrum data, red green blue (RGB) data, one or more indicators of the one or more physical objects, pointing and orientation information relating to the one or more physical objects, relative location of the one or more physical objects, and/or depth information representing distances between the system and the one or more physical objects.

11. The system of claim 10, wherein the imaging data has a resolution of between 0.5 and 10 cm² per pixel at an operational range of between 2 and 100 m.

12. The system of claim 1, wherein the plurality of sensors and the one or more infrared thermal sensors operate in parallel.

13. The system of claim 1, wherein the set of steps further comprises:
using the one or more 3D maps to generate one or more thermal overlays of surfaces of the one or more physical objects; and
generating, for each of the one or more physical objects, a simulated object that has six degrees-of-freedom ephemera.

14. The system of claim 13, wherein the set of steps further comprises:
using the one or more thermal overlays to define, for each object in the one or more objects, locations and operational behaviors of internal thermal sources, external thermal sources, and/or modes of heat transfer.

15. The system of claim 14, wherein the set of steps further comprises:
using the one or more 3D maps to generate a thermodynamic and environmental model that is usable to check accuracy of the operational behaviors,
wherein the model comprises a finite element representation of each of the simulated objects.

16. A system for remote and passive mapping of one or more physical objects in space, the system comprising:
a plurality of lenses that provide a field of view for a user;
an infrared sensor that measures infrared light radiating from one or more objects within the field of view;
a plurality of visible spectrum sensors that measure visible light and radiation from the one or more objects within the field of view;
one or more electronic circuits and/or computer processors that process data provided by both the infrared sensor and the plurality of visible spectrum sensors, thereby generating information for a user; and
a viewing area that displays the information to the user.

17. The system of claim 16, wherein the information comprises a visual image of the field of view and a thermal image of the field of view.

18. The system of claim 16, wherein the one or more electronic circuits and/or computer processors analyze the data to determine, within a body-centric reference frame, six degree-of-freedom orientation and navigation vectors for the one or more physical objects.

19. A method for mapping one or more objects in a field of view, the method comprising:
collecting a plurality of images of one or more objects in a field of view, wherein the plurality of images comprise one or more images in the visible portion of the electromagnetic spectrum and one or more images in the infrared portion of the electromagnetic spectrum;
performing infrared filtering of the plurality of images;
performing blob detection of the plurality of images;
performing a visible spectrum object offset comparison of the plurality of images;
determining one or more distances between the one or more objects;
determining one or more sizes of the one or more objects; and
processing the one or more distances and the one or more sizes to determine location and displacement of the one or more objects along a Z-axis extending towards and away the field of view, thereby determining movement of the one or more objects along the Z-axis.

20. The method of claim 19, further comprising:
after the performing of the blob detection, comparing the plurality of images frame by frame to determine movement of the one or more objects along an X-axis extending left to right in the field of view, and to determine movement of the one or more objects along a Y-axis extending up and down in the field of view.

21. The system of claim 1, wherein the set of steps further comprises:
utilizing the thermal data to generate one or more heat maps of the one or more objects.

22. The system of claim 1, wherein the set of steps further comprises:
utilizing the thermal data to determine existence and/or position of one or more thermal anomalies underneath a surface of the one or more physical objects.

23. The system of claim 1, wherein the set of steps further comprises:
comparing the thermal data to expected thermal properties of the one or more physical objects; and
identifying thermal abnormalities in the one or more physical objects.

24. The system of claim 23, wherein the set of steps further comprises:
diagnosing the thermal abnormalities using, at least in part, the imaging data, wherein the imaging data comprises one or more indicators of the one or more physical objects, pointing and orientation information relating to the one or more physical objects, relative location of the one or more physical objects, and/or depth information representing distances between the system and the one or more physical objects.
